(19) United States
(12) Patent Application Publication
(10) Pub. No.: US 2018/0112439 A1
(43) Pub. Date: Apr. 26, 2018

(54) INTEGRATED PACKAGE THEFT DETERRENT ASSEMBLY

(71) Applicant: Vache Darakdjian, San Bruno, CA (US)

(72) Inventor: Vache Darakdjian, San Bruno, CA (US)

(21) Appl. No.: 15/332,009

(22) Filed: Oct. 24, 2016

(51) Int. Cl. E05B 73/00; B65D 79/00; E05B 67/00

(52) U.S. Cl. CPC E05B 73/0005; E05B 67/003; B65D 79/00

(57) ABSTRACT

An integrated package theft deterrent assembly provides a deterrent to unauthorized removal of a package. The assembly includes a package lock device that securely fastens to inner and outer surfaces of the package. The package lock device has a first ring that is operable with a second ring to create clasping and frictional forces against inner and outer surfaces of package. The first and second ring are joined at one end through an arcuately-curved interconnecting portion that exerts a clasping force along substantially the full length of the rings. An external lock apparatus having, a first lock and a second lock tethered together by a cable. The first lock fastens to the mounting surface while attached to a first end of a cable. The second lock fastens to the package by passing through the aperture formed in the second ring while attached to a second end of the cable.

### FIELD OF THE INVENTION

The present invention relates generally to an integrated package theft deterrent assembly. More so, the present invention relates to an integrated package theft deterrent assembly that acts as both a visual and a physical deterrent to unauthorized removal, theft, and vandalism of at least one package from a package area; whereby the integrated package theft deterrent assembly includes a package lock device defined by a first ring that is operable with a second ring disposed generally coplanar and concentric to the first ring and attached through an arcuately-curved interconnecting portion that exerts a clasping force along substantially the full length of the rings; whereby the rings utilize torsion and elasticity to clamp together, and friction between the package lock device and outer and inner surfaces of the package to securely fasten to the package; whereby the assembly further comprises an external lock apparatus that securely tethers the package lock device, and package, to a mounting surface; whereby the external lock apparatus comprises a first lock that detachably fastens to the mounting surface, a second lock that detachably fastens to the second ring of the package lock device, and a cable that visibly extends between the first lock and the second lock.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known in the art that with the increase in internet sales, and home and business deliveries of merchandise by courier services there exists significant incidences of theft following their deliveries when no one is available to receive the package of merchandise. The shipment of packages for delivery to a home or office has been a cumbersome and time-consuming process for both the commercial carrier delivering the parcel and for the parcel recipient.

Typically, a commercial carrier drops a package in an unsecured area near the front entrance of a building, such as near the front porch area of a home or office. The package is generally visible and accessible to anyone in the area. This practice carries the obvious liability of exposing the commercial carrier and the recipient to the risk that the unsecured package may be stolen or possibly damaged by exposure to environmental elements

Generally, a package can be secured in a lock box or tethered to a secure object through various locking mechanisms. One commonly used locking mechanism is a padlock. Padlocks are portable locks with a shackle that may be passed through an opening to prevent use, theft, vandalism, or harm. A key is a device that is used to operate a lock, such as to lock or unlock the padlock. A typical key is a small piece of metal consisting of two parts: the blade, which slides into the keyway of the lock and distinguishes between different keys, and the bow, which is left protruding so that torque can be applied by the user. The key is usually intended to operate one specific lock or a small number of locks that are keyed alike, so each lock requires a unique key.

Other proposals have involved security systems and methods for protecting mailed packages from theft and unauthorized access. The problem with these gripping devices is that they do not create a visual and physical deterrent from both the package area and the package itself. Also, the locking mechanism is not easy to attach to the package. Even though the above cited locking devices meets some of the needs of the market, an integrated package theft deterrent assembly that acts as both a visual and a physical deterrent to unauthorized removal, theft, and vandalism of at least one package from a package area through a package lock device that integrates into the package through clasping and frictional forces, and a tethered external lock apparatus that fastens to a mounting surface is still desired.

### SUMMARY

Illustrative embodiments of the disclosure are generally directed to an integrated package theft deterrent assembly. The assembly provides both a visual and a physical deterrent to unauthorized removal, theft, or vandalism of at least one package from a package area. In some embodiments, the assembly may include a package lock device that securely fastens to inner and outer surfaces of the package through applied clasping and frictional forces for securing package lock device to the package. The package lock device may be integrated into the package during fabrication, or fastened into the package prior to shipping. The package lock device is defined by a first ring that is operable with a second ring to create a clamping force against an inner and outer surface of the package. The rings are disposed generally coplanar to each other, with the second ring being smaller and concentrically disposed to the first ring.

In some embodiments, the first and second ring are joined at one end through an arcuately-curved interconnecting portion that exerts a clasping force along substantially the full length of the rings. In one embodiment of locking, the first ring positions coplanar to an inner surface of the package, and the second ring positions coplanar to an outer surface of the package, and in alignment with the first ring. In this manner, the rings utilize torsion and elasticity to clamp together, and friction between the package lock device and outer and inner surfaces of the package to securely fasten to the package.

In some embodiments, the assembly further comprises an external lock apparatus comprises, a first lock and a second lock tethered together by a cable. The first lock fastens to the mounting surface while attached to a first end of a cable. The second lock fastens to the package by passing through the aperture formed in the second ring while attached to a second end of the cable.

In some embodiments, the external lock apparatus may include a first lock that detachably fastens to the mounting surface. The first lock comprises a first body and a first locking mechanism. The first lock fastens to the mounting surface by enabling the first end of the cable to wrap around the mounting surface, and then securing the first end of the cable. The first body is rigid and receives the first end of the cable. The first locking mechanism may directly engage the first end into a locked position. The first locking mechanism may include, without limitation, pins, wafers, disc tumblers, or other padlock locking components known in the art. A key may be used to unlock the first locking mechanism.

The external lock apparatus may include a second lock that detachably fastens to the second ring of the package lock device. The second lock comprises a second body and a second locking mechanism. The second lock fastens to the package by enabling the second end of the cable to pass through the aperture formed in the second ring, and then securing the second end of the cable. The second body is rigid and contains the ends of the second cable as it wraps around the aperture in the second ring.

The second locking mechanism may directly engage the ends of the second end of the cable with pins, wafers, disc tumblers, or other padlock locking components known in the art. In some embodiments, the same key used to unlock the first mechanism may be used to unlock the second locking mechanism.

As discussed above, the cable has a first end that fastens to the first locking mechanism, and a second end that fastens to the second mechanism. The cable may include a flexible, security cable having overlapping steel jackets threaded over the cable to help prevent cutting of the cable. Though any secure cable known in the art may be used.

In one aspect, an integrated package theft deterrent assembly comprises:
a package lock device defined by a first ring and a second ring, the first and second rings being disposed generally coplanar to each other, the second ring being generally smaller and concentrically disposed in relation to the first ring;
an arcuately-curved interconnecting portion configured to join the first ring and the second ring, the arcuately-curved interconnecting portion configured to exert a clasping force along substantially the full length of the rings,
whereby the arcuately-curved interconnecting portion applies torque to the rings to generate the clasping force between the rings; and
an external lock apparatus comprising a first lock, a second lock, and a cable having a first end and a second end, the cable configured to tether the first lock to the second lock, the first lock configured to detachably fasten to the first end of the cable, the second lock configured to detachably fasten to the second end of the cable.

In another aspect, the first ring is generally flat.

In another aspect, the second ring is generally bowed.

In yet another aspect, the arcuately-curved interconnecting portion is tensioned in an arcuate configuration.

In yet another aspect, the arcuately-curved interconnecting portion attaches to the edges of the rings.

In yet another aspect, the first lock of the external lock apparatus comprises a first body, a first shaft, and a first locking mechanism.

In yet another aspect, the second lock of the external lock apparatus comprises a second body, a second shaft, and a second locking mechanism.

In yet another aspect, the first locking mechanism and the second locking mechanism include at least one of the following: pins, wafers, disc tumblers, padlock locking components, and a numerical combination.

In yet another aspect, the external lock apparatus further comprises a key.

In yet another aspect, the package lock device is configured to fasten to a package having an inner surface and an outer surface.

In yet another aspect, the first ring engages the inner surface and the second ring engages the outer surface of the package.

In yet another aspect, the package includes at least one of the following: a corrugated box, a crate, a cylindrical container, and an envelope.

In yet another aspect, the first lock is configured to enable detachable fastening to a mounting surface.

In yet another aspect, the mounting surface includes at least one of the following: a house, a building, a door knob, a fence, a railing, a mailbox, and a mailbox post.

In another aspect, the first lock comprises a first body and a first locking mechanism.

In another aspect, the second lock comprises a second body and a second locking mechanism.

In yet another aspect, the second end of the cable comprises a ridge.

In yet another aspect, the cable is configured to resist being cut.

One objective of the present invention is to inhibit theft of packages delivered to a package delivery area.

Another objective is to provide a visual and physical deterrent to unauthorized access and manipulation to package in a package area.

Another objective is to apply a clasping force to the inner and outer surfaces of the package to fasten a package lock device thereto.

Yet another objective is to provide a locking mechanism that utilizes a code or combination known only by authorized recipients of the package.

Yet another objective is to enable detachable fastening to various types of mounting surfaces, such as door knobs, mailboxes, and rails.

Yet another objective is to provide an inexpensive to manufacture package theft deterrent assembly.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary integrated package theft deterrent assembly, in accordance with an embodiment of the present invention;

FIG. 2 illustrates an elevated side view of an exemplary package lock device, in accordance with an embodiment of the present invention;

FIG. 3 illustrates a frontal view of a package lock device and a second end of a cable, in accordance with an embodiment of the present invention;

FIG. 4 illustrates a perspective view of an exemplary first ring against an inner surface of a package, in accordance with an embodiment of the present invention;

FIG. 5 illustrates a perspective view of an exemplary second ring against an outer surface of a package, in accordance with an embodiment of the present invention;

FIG. 6 illustrates a perspective view of an exemplary external lock apparatus, in accordance with an embodiment of the present invention; and

FIG. 7 illustrates a perspective view of an exemplary second lock of the external lock apparatus fastened to the second ring of the package lock device, in accordance with an embodiment of the present invention.

Like reference numerals refer to like parts throughout the various views of the drawings.

### DETAILED DESCRIPTION OF THE INVENTION

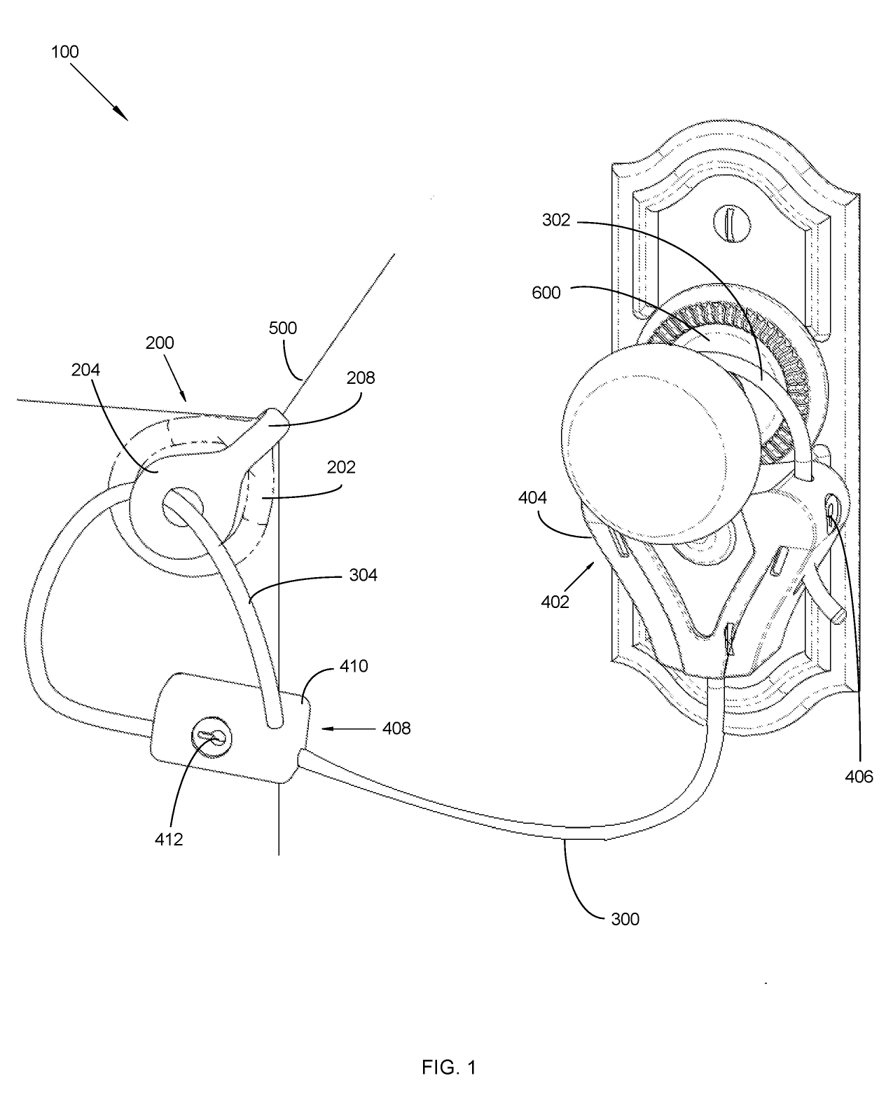

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

An integrated package theft deterrent assembly 100 is referenced in FIGS. 1-7. The integrated package theft deterrent assembly 100, hereafter “assembly 100” serves as both a visual and a physical deterrent to unauthorized removal, theft, or vandalism of at least one package 500 from a package area.

As illustrated in FIG. 1, assembly 100 utilizes a cable 300 that extends between a package lock device 200 integrated into at least one package 500, and an external lock apparatus 400 fastened to a mounting surface 600. The cable 300 and locks 200, 400 are clearly visible from the package area, so as to deter attempts at theft and unauthorized access. Also, the cable 300 and locks 200, 400 are configured with unique security features that physically restrict removal of the package from the package area.

In some embodiments, the at least one package 500 may include, without limitation, a corrugated box, a crate, a cylindrical container, and an envelope, such as used for shipping items. The package may contain items having some monetary or sentimental value that requires protection from unauthorized access. The package 500 may have a plurality of sidewalls defined by a cavity. The sidewalls comprise an inner surface 502 and an outer surface 504 to which the package lock device 200 securely fastens. The package area may include a porch or lobby of a residence or office; especially outdoors. The package area may have a mounting surface 600 to which the external lock apparatus 400 securely fastens.

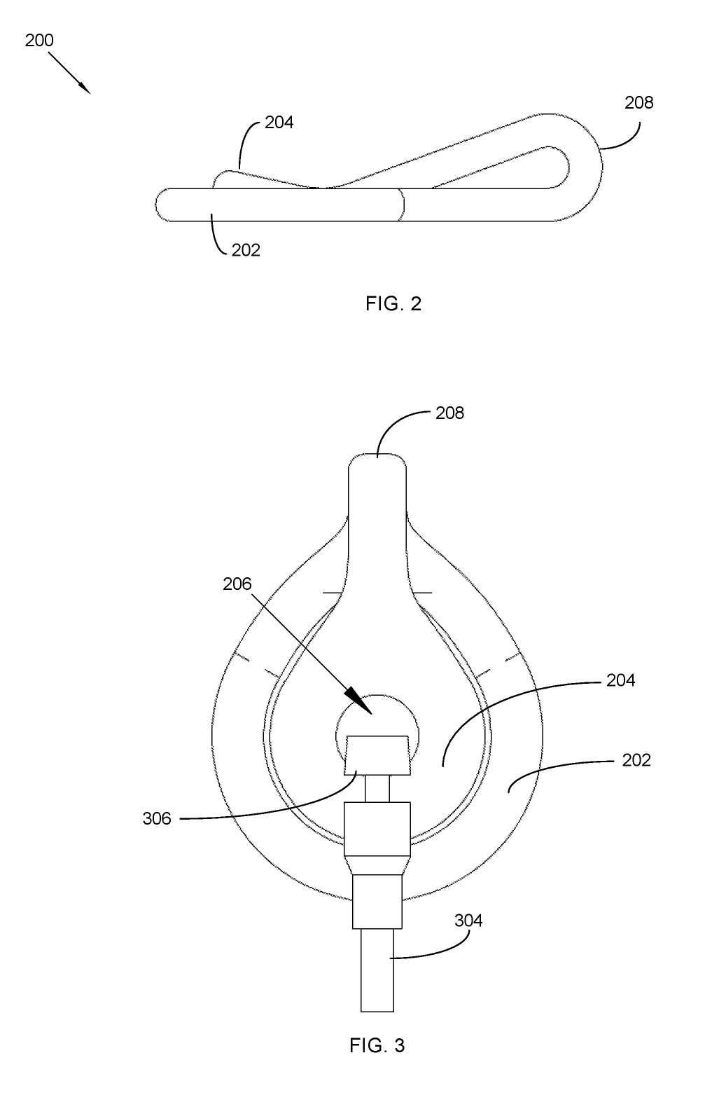

As shown in FIG. 2, assembly 100 comprises a package lock device 200 that securely fastens to inner and outer surfaces 502, 504 of the package 500 through applied clasping and frictional forces. Package lock device 200 is configured to leverage the inner and outer surface area of the package 500, so as to create both clasping and frictional forces for securing package lock device 200 to package 500. In some embodiments, package lock device 200 may be integrated into the package during fabrication. In this manner, package lock device 200 provides security from within the package 500, and security extended from the interior of package 500. The frictional engagement creates a difficult mechanism to remove the package lock device 200 without damaging package 500 or requiring a long duration to do so.

In other embodiments, package lock device 200 is manually fastened into the package prior to shipping. In yet other embodiments, multiple packages may each have separate package lock devices, so as to be secured together in the same package area. In yet other embodiments, package lock device 200 is operable by a human or a machine to lift, lower, drop, or move a package, or to link two packages together.

In one embodiment, the package lock device 200 is defined by a first ring 202 and a second ring 204 that are connected with a torque inducing interconnecting portion 208. The rings 202, 204 and interconnecting portion 208 are adapted to form a paperclip configuration. In some embodiments, second ring 204 is smaller and concentrically disposed to first ring 202. In one embodiment shown in FIG. 3, first ring 202 is generally flat, and second ring 204 has a slight bend. In some embodiments, the rings 202, 204 are generally circular, or slightly elongated to form an oval shape.

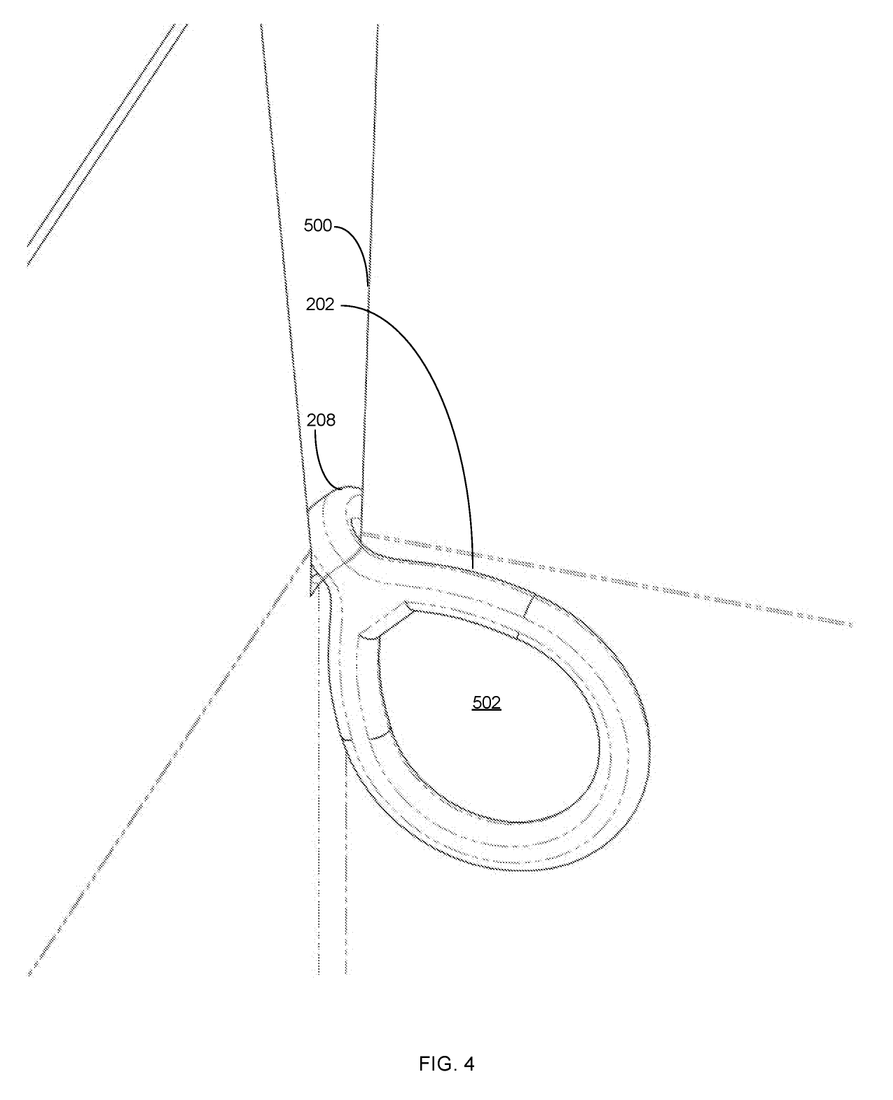

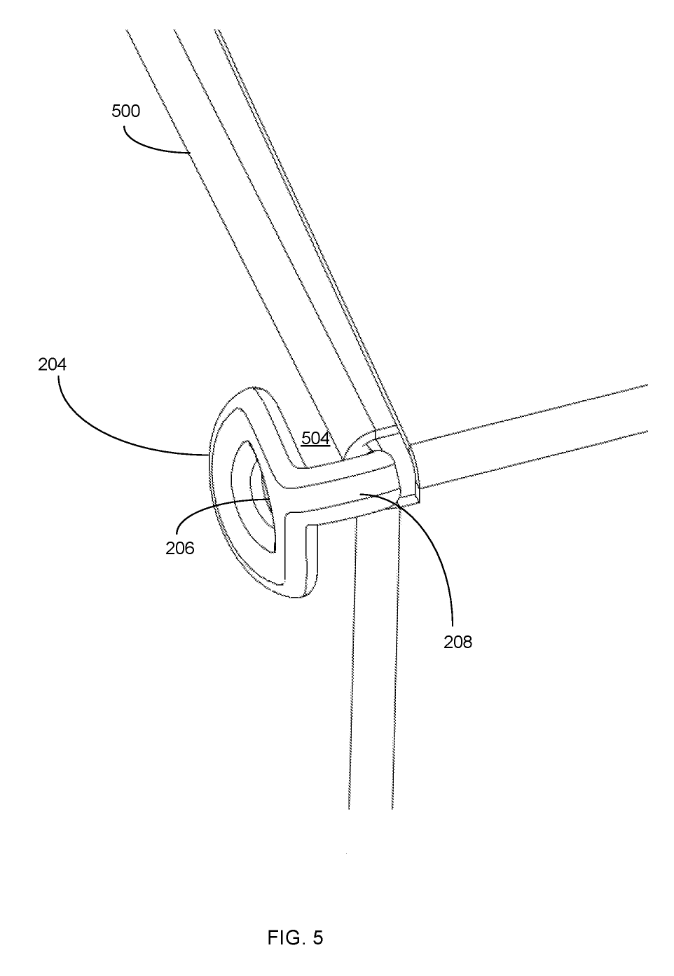

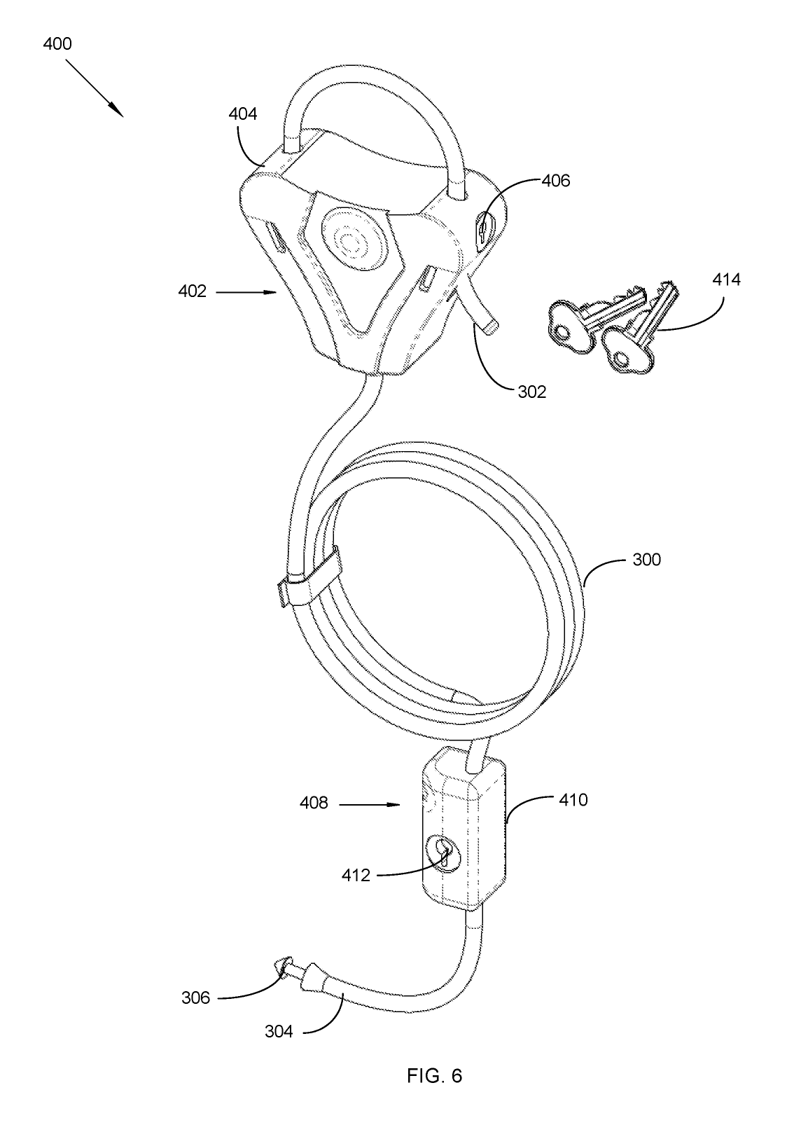

In some embodiments, rings 202, 204 are disposed generally coplanar to each other. In another embodiment of locking shown in FIG. 4, the first ring 202 positions coplanar to an inner surface 502 of the package 500. The smaller second ring 204 positions coplanar to an outer surface 504 of the package, in general alignment with first ring 202. As FIG. 5 illustrates, second ring 204 extends from the package during transport. This visibility provides a visual deterrent to unauthorized access to the package, or theft of the package from the package area or during shipping.

Looking back at FIG. 3, second ring 204 is defined by a central aperture 206 that is exposed outside of the package 500 and used to fasten to the cable 300. First ring 202 positions firmly inside the package 500. First ring 202 and second ring 204 are operable to create a clasping force against the inner and outer surface 502, 504 of the package 500. The clasping force is sufficient to securely retain the package lock device 200 on the package 500.

In some embodiments, first and second rings 202, 204 are joined at one end through an arcuately-curved interconnecting portion 208. Interconnecting portion 208 is tensioned in an arcuate configuration. Interconnecting portion 208 is configured to exert a clasping force along substantially the full length of the rings. While clasped to the package, the first ring 202 positions coplanar to the inner surface 502 of package 500. Also, second ring 204 positions coplanar to an outer surface 504 of package 500, in alignment with first ring 202. In this manner, the rings 202, 204 utilize torsion and elasticity to clamp together. Rings 202, 204 also utilize friction against the outer and inner surface 502, 504 of the package 500 to securely fasten to package 500.

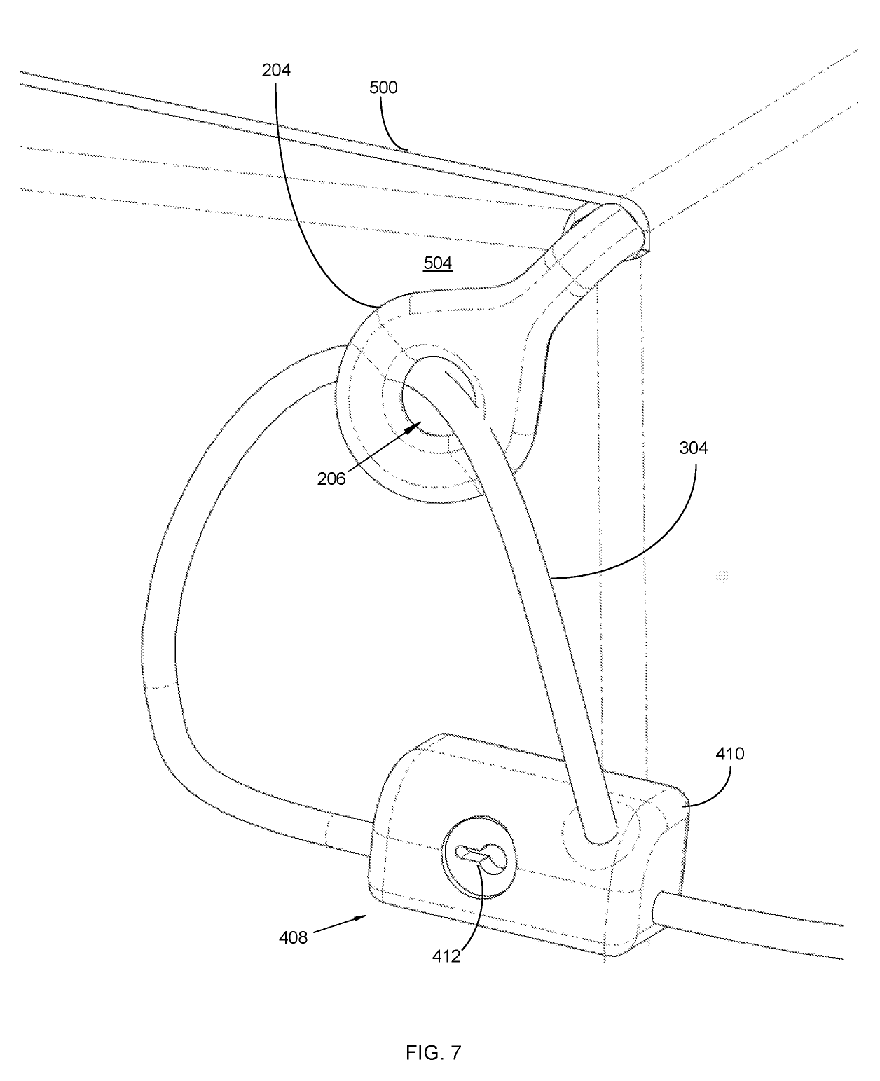

As referenced in FIG. 6, assembly 100 further comprises an external lock apparatus 400 comprising, a first lock 402 and a second lock 408 that are tethered together by a cable 300. First lock 402 fastens to the mounting surface 600 while attached to a first end 302 of a cable 300. As discussed above, mounting surface 600 may include, without limitation, a house, a building, a door knob, a fence, a railing, a mailbox, and a mailbox post.

Second lock 408 fastens to the package 500 by enabling the second end 304 of the cable 300 to pass through the aperture 206 formed in second ring 204, and then locking the second end 304 of the cable 300 in a closed loop through second lock 408. In one alternative embodiment, cable 300 may pass through multiple second ring apertures in multiple packages arranged in series in the package area.

In some embodiments, external lock apparatus 400 may include a first lock 402 that detachably fastens to the mounting surface 600. First lock 402 comprises a first body 404 and a first locking mechanism 406. Cable 300 may pass through first locking mechanism 406, as second end 304 of the cable 300 forms a loop that wraps around mounting surface 600. In some embodiments, first locking mechanism 406 may include, without limitation, pins, wafers, disc tumblers, or other padlock locking components known in the art. In one alternative embodiment, first lock 402 may also utilize a first shackle having a generally U-shape that encompasses mounting surface 600. In this configuration, the body is rigid and contains the ends of the first shackle and first locking mechanism 406.

As FIG. 6 shows, a key 414 may be used to unlock the first lock 402ing mechanism. Key 414 may include any key known in the art having a blade that slides into a keyway, and a blade for manipulating the key 414. However, in other embodiments, other locking and unlocking means known in the art may be used to unlock the first locking mechanism 406.

Looking now at FIG. 7, external lock apparatus 400 may include a second lock 408 that detachably fastens to second ring 204 of the package lock device 200. Second lock 408 comprises a second body 410 and a second locking mechanism 412. Second lock 408 fastens to the package 500 by enabling the second end 304 of the cable 300 to pass through the aperture 206 formed in the second ring 204, and then locking the second end 304 of the cable 300 with second locking mechanism 412.

Similar to first lock 402, the second lock 408 may have an alternative embodiment with a second shackle that encompasses the second ring 204. The second body 410 is rigid and contains the second end 304 of cable 300 as it wraps around the aperture 206 in the second ring 204. Second locking mechanism 412 may directly engage the ends of second end 304 of cable 300 with pins, wafers, disc tumblers, or other padlock locking components known in the art. However in alternative embodiments, a second shackle having a generally U-shape may be used to encompasses the second ring 204.

As shown in the perspective illustration of FIG. 7, second end 304 of cable 300 forms a loop through second lock 408, and passes through the aperture 206 formed in the second ring 204. In one embodiment shown in FIG. 3, second end 304 of cable 300 comprises a ridge 306 that couples inside second locking mechanism 412. In some embodiments, the same key 414 used to unlock the first locking mechanism 406 may be used to unlock the second locking mechanism 412. However, in other embodiments, other locking and unlocking means known in the art may be used to unlock the second locking mechanism 412.

As discussed above, cable 300 has a first end 302 that fastens to the first locking mechanism 406, and a second end 304 that fastens to the second locking mechanism 412. Cable 300 may include a flexible, security cable having overlapping steel jackets threaded over the cable, a chain, or a synthetic security material to help prevent cutting of the cable 300. Though any secure cable known in the art may be used.

In operation of the assembly 100, prior to folding closed the lid of the package, package lock device 200 is hung from any corner of the package's lid. First ring 202 is positioned against inner surface 502 of the package 500, while the second ring 204 protrudes over a corner vertex of the package, along the outer surface 504. Once the package lids are folded shut, and standard tape is applied to seal the package, package lock device 200 is arbitrarily secured into its position and cannot be manipulated or removed without reopening the package. The only section remaining visible from outside package 500 is the second ring 204, which protrudes from the corner vertex hole of the package 500.

Upon arriving at the package area, second end 304 of the cable 300 is passed through the aperture 206 in second ring 204. First end 302 of the cable 300 wraps around mounting surface 600 and fastens into first lock 402. In this arrangement, cable 300 visibly extends from mounting surface 600 to package 500. This tethered arrangement serves to create a deterrent against theft to parcel or package. In this manner, assembly 100 is especially effective for inhibiting theft of a delivered package from a porch of a residence.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An integrated package theft deterrent assembly, the assembly comprising:
a package lock device defined by a first ring and a second ring, the first and second rings being disposed generally coplanar to each other, the second ring being generally smaller and concentrically disposed in relation to the first ring;
an arcuately-curved interconnecting portion configured to join the first ring and the second ring, the arcuately-curved interconnecting portion configured to exert a clasping force along substantially the full length of the rings,
whereby the arcuately-curved interconnecting portion applies torque to the rings to generate the clasping force between the rings; and
an external lock apparatus comprising a first lock, a second lock, and a cable having a first end and a second end, the cable configured to tether the first lock to the second lock, the first lock configured to detachably fasten to the first end of the cable, the second lock configured to detachably fasten to the second end of the cable.

2. The assembly of claim 1, wherein the first ring is generally flat.

3. The assembly of claim 1, wherein the second ring is generally bowed.

4. The assembly of claim 1, wherein the arcuately-curved interconnecting portion is tensioned in an arcuate configuration.

5. The assembly of claim 1, wherein the first lock of the external lock apparatus comprises a first body and a first locking mechanism.

6. The assembly of claim 5, wherein the second lock of the external lock apparatus comprises a second body and a second locking mechanism.

7. The assembly of claim 6, wherein the first locking mechanism and the second locking mechanism include at least one of the following: pins, wafers, disc tumblers, padlock locking components, and a numerical combination.

8. The assembly of claim 7, wherein the external lock apparatus further comprises a key, the key configured to lock and unlock the first lock, or the second lock, or both.

9. The assembly of claim 1, wherein the package lock device is configured to fasten to at least one package having an inner surface and an outer surface.

10. The assembly of claim 9, wherein the first ring engages the inner surface and the second ring engages the outer surface of the at least one package.

11. The assembly of claim 10, wherein the at least one package includes at least one of the following: a corrugated box, a crate, a cylindrical container, and an envelope.

12. The assembly of claim 11, wherein the first lock is configured to enable detachable fastening to a mounting surface.

13. The assembly of claim 12, wherein the mounting surface includes at least one of the following: a house, a building, a door knob, a fence, a railing, a mailbox, and a mailbox post.

14. The assembly of claim 13, wherein the cable is defined by a first end configured to join with the first lock, and a second end configured to join with the second lock.

15. The assembly of claim 14, wherein the second end of the cable comprises a ridge.

16. An integrated package theft deterrent assembly, the assembly comprising:
a package lock device defined by a first ring and a second ring, the first and second rings being disposed generally coplanar to each other, the second ring being generally smaller and concentrically disposed in relation to the first ring; and
an arcuately-curved interconnecting portion configured to join the first ring and the second ring, the arcuately-curved interconnecting portion configured to exert a clasping force along substantially the full length of the rings,
whereby the arcuately-curved interconnecting portion applies torque to the rings to generate the clasping force between the rings.

17. The assembly of claim 16, wherein the package lock device is operable by a human or a machine to lift, lower, drop, or move a package, or to link two packages together.

18. An integrated package theft deterrent assembly, the assembly comprising:
an external lock apparatus comprising a first lock, a second lock, and a cable having a first end and a second end, the cable configured to tether the first lock to the second lock, the first lock configured to detachably fasten to the first end of the cable, the second lock configured to detachably fasten to the second end of the cable; and
a key configured to lock and unlock the first lock, or the second lock, or both.

19. The assembly of claim 18, wherein the first lock comprises a first body and a first locking mechanism.

20. The assembly of claim 18, wherein the second lock comprises a second body and a second locking mechanism.
